(19) United States
(12) Patent Application Publication
(10) Pub. No.: US 2021/0304483 A1
(43) Pub. Date: Sep. 30, 2021

(54) IMPLEMENTATION OF AN ATLAS-SPACE SHADOW MASK

(71) Applicant: QUALCOMM Incorporated, San Diego, CA (US)

(72) Inventors: Joseph Daniel Garvey, San Diego, CA (US); Dieter Schmalstieg, Graz (AT); Bojan Vrcelj, San Diego, CA (US)

(21) Appl. No.: 16/828,808

(22) Filed: Mar. 24, 2020

(51) Int. Cl. G06T 15/00; G06T 7/37; G06T 15/04; G06T 15/60; G06T 7/507; G06T 7/529

(52) U.S. Cl. CPC G06T 15/005; G06T 7/37; G06T 15/04; G06T 2215/12; G06T 7/507; G06T 7/529; G06T 15/60

(57) ABSTRACT

Methods, systems, and devices for computer graphics are described. A device may perform a shadow rendering operation in an object-space shading pipeline for a set of potentially visible surfaces. The device may represent the potentially visible surfaces in an atlas. The device may determine a set of world-space coordinates corresponding to the one or more potentially visible surfaces and may store the set of world-space coordinates in a geometry buffer (G-buffer). The device may determine a number of shadow factors associated with the potentially visible surfaces based on a transformation of the world-space coordinates stored in the G-buffer and a set of depth values associated with each shadow caster present in a scene. The device may store the shadow factors in an atlas shadow mask and perform a shading of the potentially visible surfaces in the atlas based on the atlas shadow mask.

### FIELD OF TECHNOLOGY

The following relates generally to computer graphics and more specifically to an implementation of an atlas-space shadow mask.

### BACKGROUND

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include wireless communications systems, entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices. As demand for multimedia communication efficiency increases, some multimedia systems may fail to provide satisfactory multimedia operations for multimedia communications, and thereby may be unable to support high reliability or low latency multimedia operations, among other examples.

### SUMMARY

A device may employ a rendering pipeline that may determine and execute shading for a number of shadowed surfaces by generating a shadow mask conveying information about shadows caused by each light source (e.g., each shadow caster) present in a scene. In some cases, a number of shadow masks may be equal to a number of shadow casters influencing a given portion of the scene. The number of shadow masks may, in some examples, be used to simplify light computations associated with shading the number of surfaces. In some cases, each individual shadow mask may correspond to the position and orientation of each shadow caster, which may be fixed or may change over time. This simplified computation of lighting on shadowed surfaces may be valid for one unique camera position and orientation (e.g., a single viewpoint or view) and, likewise, may create artifacts (e.g., visual errors) in a rendering system that allows for producing simultaneous renditions from multiple camera views, such as a virtual reality application including two camera views (e.g., one camera view per eye).

Some rendering systems that support simultaneous viewing from multiple viewpoints may employ an object-space (or a texture-space) rendering pipeline. An object-space or a texture-space rendering pipeline may be implemented by a split rendering system, where surfaces (e.g., potentially visible surfaces in a rendered scene) may be shaded on a server device and organized into an atlas structure used for storing shading information (e.g., a shading atlas used as an interface between a shading operation and a scene reconstruction), as well as processed (e.g., consumed) on a client device from a nearby and more recent viewpoint (e.g., an arbitrary or nearby viewpoint used to rasterize the scene onto a frame). In some other examples, an object-space rendering system may be integrated with the object-space representation consumption system (i.e., the server subsystem and the client subsystem may be integrated within the same device) and may similarly employ a shading atlas to store the shading information of potentially visible surfaces and rasterize the scene onto an image plane from an arbitrary or nearby viewpoint using the surfaces within the shading atlas.

Some object-space rendering pipelines may use alternative shading methods to shading methods involving a shadow mask and may thus incur higher computational costs. Further, some methods of shadow mask generation may be incompatible with object-space rendering because the graphics elements considered as stepping stones in some techniques of generating shadow masks may be obtained for a single, unique camera view, while object-space rendering may use graphics elements that are valid for a number of different views, and these graphics elements may include shading information for surfaces that may be invisible from some views and potentially visible from other nearby views. The described techniques relate to configuring a device to support a shadow mapping technique in an object-space rendering pipeline which may be used for efficiently generating an atlas-space representation of a shadow mask, the shadow mask designed to remain valid for not just the current camera viewpoint but also a set of nearby viewpoints. In some examples, the atlas-space shadow mask (or atlas shadow mask) may enable an object-space rendering device to simplify (in some cases, significantly simplify) lighting computation for certain surfaces, while maintaining a realism of shading for all surfaces.

In some examples, to generate shadow masks that may be compatible with object-space rendering (e.g., a shadow mask that provides accurate shadowing information for a number of views near a predicted view at a time of final rendering), the device (e.g., a server device) may generate an atlas shadow mask and may employ a geometry buffer (G-buffer) representation of the scene as well as a number of shadow maps in order to facilitate the generation of the atlas shadow mask. Such G-buffers may be called atlas G-buffers and may be used as intermediary buffers to store world-space positions of the texels on surfaces that may be visible from viewpoints within a vicinity of (i.e., nearby) a current viewpoint of a virtual camera used to render the scene (e.g., an animated scene). For instance, such texels may be at least partially visible from at least one of a number of virtual camera positions or orientations as described by a viewcell surrounding a predicted camera position and orientation at the time of final rendering. Accordingly, the described techniques may support establishing a unique correspondence between potentially visible surfaces associated with a multitude of potential virtual camera viewpoints and the corresponding elements in the individual shadow maps associated with each shadow caster that is static in position and orientation. Such correspondences are based on (i.e., made possible in part by) computing and storing the world-space coordinates of potentially visible texels in the atlas G-buffer for re-use. Upon establishing such correspondences, the device may generate shadow factors corresponding to each of a multitude of potentially visible texels. Such shadow factors may be organized and stored in an atlas shadow mask and used in an object-space rendering pipeline to simplify a lighting computation while preserving realism and accuracy of shadows in a rendered scene (e.g., in a rendered scene associated with a more recent view nearby a view used to determine the shadowing information, such as those rendered by cloud gaming, virtual reality, or augmented reality applications using head-mounted devices (HMDs)).

A method of computer graphics at a device is described. The method may include identifying one or more surfaces for a shading operation in an object-space shading pipeline that are represented in an atlas, determining a shadow factor associated with each texel of the number of texels based on the first influence of the first shadow caster, and storing the shadow factor for each texel of the number of texels in an atlas shadow mask.

An apparatus for computer graphics at a device is described. The apparatus may include a processor, memory coupled with the processor, and instructions stored in the memory. The instructions may be executable by the processor to cause the apparatus to identify one or more surfaces for a shading operation in an object-space shading pipeline that are represented in an atlas, determine a shadow factor associated with each texel of the number of texels based on the first influence of the first shadow caster, and store the shadow factor for each texel of the number of texels in an atlas shadow mask.

Another apparatus for computer graphics at a device is described. The apparatus may include means for identifying one or more surfaces for a shading operation in an object-space shading pipeline that are represented in an atlas, determining a shadow factor associated with each texel of the number of texels based on the first influence of the first shadow caster, and storing the shadow factor for each texel of the number of texels in an atlas shadow mask.

A non-transitory computer-readable medium storing code for computer graphics at a device is described. The code may include instructions executable by a processor to identify one or more surfaces for a shading operation in an object-space shading pipeline that are represented in an atlas, determine a shadow factor associated with each texel of the number of texels based on the first influence of the first shadow caster, and store the shadow factor for each texel of the number of texels in an atlas shadow mask.

Some examples of the method, apparatuses, and non-transitory computer-readable medium described herein may further include operations, features, means, or instructions for determining a set of world-space coordinates for the number of texels corresponding to the one or more surfaces and storing the set of world-space coordinates in an atlas G-buffer, and determining the first influence of the first shadow caster on the one or more surfaces based at least in part on the set of world-space coordinates and a first set of depth values associated with the first shadow caster.

In some examples of the method, apparatuses, and non-transitory computer-readable medium described herein, determining the first influence of the first shadow caster on the one or more surfaces further may include operations, features, means, or instructions for generating a second set of depth values corresponding to the set of world-space coordinates transformed to a first light-space associated with the first shadow caster based on projecting the world-space coordinates into the first light-space. Such examples may further include comparing the second set of depth values to the first set of depth values.

Some examples of the method, apparatuses, and non-transitory computer-readable medium described herein may further include operations, features, means, or instructions for determining a non-empty space in the atlas based at least in part on constructing a stencil mask of a set of integers, where a first integer is associated with an empty space in the atlas and a second integer is associated with the non-empty space in the atlas, and transforming the set of world-space coordinates associated with the non-empty space in the atlas.

In some examples of the method, apparatuses, and non-transitory computer-readable medium described herein, transforming the set of world-space coordinates into the first light-space further may include operations, features, means, or instructions for determining whether the atlas G-buffer comprises the first influence of the first shadow caster for at least a subset of the set of world-space coordinates stored in the atlas G-buffer and transforming the set of world-space coordinates that are absent of the first influence of the first shadow caster in the atlas G-buffer.

In some examples of the method, apparatuses, and non-transitory computer-readable medium described herein, the first set of depth values may be stored in a first depth map associated with the first shadow caster.

Some examples of the method, apparatuses, and non-transitory computer-readable medium described herein may further include operations, features, means, or instructions for determining a second influence of a second shadow caster on the one or more surfaces based on the set of world-space coordinates and a third set of depth values associated with the second shadow caster, updating the shadow factor associated with each texel of the number of texels based on the second influence of the second shadow caster, storing the updated shadow factor for each texel of the number of texels in the atlas shadow mask, and performing a shading for the one or more surfaces in the atlas based in part on the atlas shadow mask.

In some examples of the method, apparatuses, and non-transitory computer-readable medium described herein, determining the second influence of the second shadow caster on the one or more surfaces further may include operations, features, means, or instructions for generating a fourth set of depth values corresponding to the set of world-space coordinates transformed to a second light-space associated with the second shadow caster, and comparing the fourth set of depth values to the third set of depth values.

In some examples of the method, apparatuses, and non-transitory computer-readable medium described herein, the third set of depth values may be stored in a second depth map associated with the second shadow caster.

In some examples of the method, apparatuses, and non-transitory computer-readable medium described herein, generating the fourth set of depth values corresponding to the set of world-space coordinates transformed to the second light-space associated with the second shadow caster further may include operations, features, means, or instructions for determining the set of world-space coordinates for the number of texels corresponding to the one or more surfaces based on retrieving the set of world-space coordinates from the atlas G-buffer, where the atlas G-buffer may be a reusable atlas G-buffer, and projecting the world-space coordinates into the second light-space based on a position, an orientation, a field of view, a horizontal and vertical sampling resolution, or a combination thereof, of the second shadow caster, where projecting the world-space coordinates into the second light-space generates the fourth set of depth values.

In some examples of the method, apparatuses, and non-transitory computer-readable medium described herein, performing the shading for the one or more surfaces in the atlas further may include operations, features, means, or instructions for identifying a texel of the number of texels corresponding to the one or more surfaces, and performing a shading for the texel based in part on a corresponding shadow factor stored in the atlas shadow mask.

Some examples of the method, apparatuses, and non-transitory computer-readable medium described herein may further include operations, features, means, or instructions for generating the set of world-space coordinates corresponding to the one or more surfaces may be based on determining a world-space coordinate associated with each texel of the number of texels corresponding to the one or more surfaces.

Some examples of the method, apparatuses, and non-transitory computer-readable medium described herein may further include operations, features, means, or instructions for determining a first world-space coordinate for a first texel of the number of texels and determining the first influence of the first shadow caster on the first texel and storing the first influence of the first shadow caster on the first texel together with the first world-space coordinate for the first texel in the atlas G-buffer.

In some examples of the method, apparatuses, and non-transitory computer-readable medium described herein, a surface (e.g., a potentially visible surface) corresponds to a surface that may be visible from at least one camera position or orientation of a set of camera positions and orientations defined by a viewcell.

In some examples of the method, apparatuses, and non-transitory computer-readable medium described herein, the one or more surfaces may be represented in an atlas for consumption on a client device.

In some examples of the method, apparatuses, and non-transitory computer-readable medium described herein, the client device renders a subset of the one or more surfaces based on a current client position or orientation, or both.

In some examples of the method, apparatuses, and non-transitory computer-readable medium described herein, a scene associated with the shading operation corresponds to an at least partially animated scene.

In some examples of the method, apparatuses, and non-transitory computer-readable medium described herein, the at least partially animated scene may be used in at least one of a cloud gaming application, a virtual reality application, or an augmented reality application.

In some examples of the method, apparatuses, and non-transitory computer-readable medium described herein, the device includes a server.

In some examples of the method, apparatuses, and non-transitory computer-readable medium described herein, the device includes a user equipment.

### BRIEF DESCRIPTION OF THE DRAWINGS

FIG. 1 illustrates an example of a split-rendering system that supports an implementation of an atlas-space shadow mask in accordance with aspects of the present disclosure.

FIG. 2 illustrates an example of a graphics pipeline that supports an implementation of an atlas-space shadow mask in accordance with aspects of the present disclosure.

FIGS. 3 and 4 show block diagrams of devices that support an implementation of an atlas-space shadow mask in accordance with aspects of the present disclosure.

FIG. 5 shows a block diagram of an atlas shading manager that supports an implementation of an atlas-space shadow mask in accordance with aspects of the present disclosure.

FIG. 6 shows a diagram of a system including a device that supports an implementation of an atlas-space shadow mask in accordance with aspects of the present disclosure.

FIGS. 7 and 8 show flowcharts illustrating methods that support an implementation of an atlas-space shadow mask in accordance with aspects of the present disclosure.

### DETAILED DESCRIPTION

A device may be configured to support processing and outputting a stereoscopic multi-dimensional visualization of a scene with shadows. The device may support a shadow mapping operation (e.g., a forward screen space shadow operation) that may compute shadowing information for a number of potentially visible surfaces associated with a rendered scene. In some cases, the device may use a split rendering system (e.g., a distributed graphics pipeline) between a server and a client device to render and reconstruct a scene. For instance, the server device may render a scene and transport the rendered scene to the client device, which may reconstruct the scene. Based on using a distributed graphics pipeline, a lighting operation, a shading operation, and a display operation associated with the input scene may occur asynchronously and, in some cases, prolonged transport delays may result in some pixels becoming visible to the client device prior to being shaded by the server.

For example, when using a forward screen-space shadow operation with vector streaming (which may be associated with a split rendering system), the information available to the client device may become stale, such that some texels of potentially visible surfaces in a scene may become visible to the client device without the texels being shaded by the server. For example, there may be a number of texels that are occluded from the view of the server but become visible to the client device when the client device renders a scene, which may be associated with a view which occluded later in time compared to the view used by the server to compute the shadowing information. In such cases, a screen-space rendering pipeline for generating shadow information may result in visible errors (e.g., visible artifacts, such as disoccluded surfaces missing shadows). For example, the client device may reconstruct (e.g., output or display) a visualization of the scene without fully accurate shading of the scene.

Additionally or alternatively, techniques for screen-space shading (e.g., such as the use of screen-space shadow masks) may be incompatible with some applications, such as cloud gaming, virtual reality, or augmented reality video game applications that support multiple viewpoints (e.g., multiple camera views, such as two views corresponding to two eyes) of a scene. For example, the server device, using screen-space shading, may generate a shadow mask associated with a single, unique view, which may not include shadowing information for views other than the single, unique view. As such, if the client uses a rendering system that supports multiple views or a more recent view than the view used to generate the shadow mask, or both, visible errors associated with missing shadow information may appear in one or more of the views used by the client, which may result in a degradation of a perceived realism and a user experience.

Accordingly, devices that support multiple views may use object-space rendering systems involving alternatives to shadow masks to maintain realism in each of the multiple views. Some processing pipelines associated with alternatives to shadow masks may be associated with higher computational costs than processing pipelines implementing the use of shadow masks. As such, it may be desirable for a device to implement an object-space rendering system in a manner that supports the use of shadow map-based rendering simplifications via a shadow mask generation technique that is compatible with (e.g., stores shadowing information for) a plurality of views that the client may use at a time of final rendering.

In some implementations of the present disclosure, a device (e.g., a server, or a client device in the case of an integration of an object-space rendering system with the object-space consumption system) may identify a set of potentially visible surfaces to represent in an atlas for consumption (e.g., consumption by the client device). In some examples, the atlas may be used to store shadowing information associated with the set of potentially visible surfaces and may be referred to as a shading atlas. The set of potentially visible surfaces may include a number of texels (e.g., locations in a texture-space) that may potentially be visible to one or more camera views of the scene, where one or more camera views may be several or a multitude of positions and orientations where cameras could be located in a future point in time (e.g., at a time of display). In some aspects, the device may generate world-space coordinates associated with the texels of the potentially visible surfaces and may store the world-space coordinates in a buffer, such as a geometry buffer (G-buffer). In some examples, the G-buffer may be represented in the atlas-space and may be referred to as an atlas G-buffer.

In some examples, the device may store the world-space coordinates of the potentially visible surfaces in an atlas G-buffer and may use the world-space coordinates stored in the atlas G-buffer to determine an influence of a number of shadow casters associated with a scene based on the viewpoint of each of the shadow casters present in the scene. For example, a shadow caster may be associated with a viewpoint of the potentially visible surfaces and a first set of depth values stored in a depth map associated with the viewpoint of the shadow caster. The device may determine an influence of the shadow caster on the potentially visible surfaces based on the depth map of the shadow caster and a projection of the world-space coordinates into the light-space of the shadow caster, which may be a shadow caster-centric frustum. For example, based on projecting the world-space coordinates into the light-space of the shadow caster, the device may determine a second set of depth values. The device may compare the second set of depth values to the first set of depth values to determine the influence of the shadow caster. The device may use the determined influence of the shadow caster to determine a shadow factor associated with each texel of the potentially visible surfaces and may store the shadow factors in a shadow mask.

In some examples, the shadow mask may be in the atlas-space or may otherwise be compatible with the atlas-space and, as such, the shadow mask may be referred to as an atlas space shadow mask or an atlas shadow mask. The device may update the atlas shadow mask for each of the number of additional shadow casters that influence at least a portion of the potentially visible surfaces with a similar procedure such that the atlas shadow mask, at the time of rendering, may include influence information for all relevant shadow casters on each of the potentially visible surfaces (e.g., the potentially visible texels corresponding to the potentially visible surfaces). For example, the device may identify that a second shadow caster also influences a subset of potentially visible surfaces and may determine the influence of the second shadow caster based on comparing a set of depth values corresponding to a projection of the world-space coordinates into the light-space of the second shadow caster with the set of depth values stored in the depth map of the second shadow caster. The device may use the determined influence to update the shadow factors corresponding to the texels influenced by the second shadow caster. The device may store the updated shadow factors in the atlas shadow mask (e.g., may accumulate the influence of the first shadow caster and the second shadow caster in the atlas shadow mask).

In some implementations, the device may execute a final shade for the potentially visible surfaces based in part on the atlas shadow mask. For example, the device may accumulate the influence (e.g., the shadow factors) of each shadow caster on the potentially visible surfaces and apply the accumulated influence of the shadow casters from the atlas shadow mask to the potentially visible surfaces in the atlas. Such an application of the shadowing information stored in the atlas shadow mask to the potentially visible surfaces in the atlas may be referred to as shading shadows into the atlas.

In some further implementations, the server may determine the non-empty space in the atlas before the shadow projection operation (e.g., the operation of transforming the world-space coordinates into a light-space of a shadow caster). This determination of the non-empty portions in the atlas may be used such that the shadow projection operations may avoid unnecessarily projecting the empty portions of the atlas. In some cases, this may reduce the overall complexity of the shadow projection pixel shaders. In some specific examples, determining the nonempty space in the atlas may be done by constructing a stencil mask consisting of 0's and 1's used to mark the nonempty space in the atlas. In some instances, the operation of creating the stencil mask may be done in parallel while populating the atlas G-buffer with the world-space coordinates of the potentially visible texels (e.g., the texels corresponding to the potentially visible surfaces). Accordingly, the server may implement the stencil mask in order to reduce the combinatorial explosion of projection operators from all surfaces in the atlas (including the empty ones) to all light-spaces, which may include a large number of unnecessary operations and computations by the processing components of the server.

Further, to potentially save computation beyond a single frame (e.g., across a number of frames), the information associated with an influence of a shadow caster (or the influence of a number of shadow casters) on a texel may be stored or recorded together with the world-space coordinate of the texel in the atlas G-buffer. In a subsequent frame, the server may check whether the influence of a number of shadow casters has already been computed for this texel or not. As such, if the texel is encountered in the subsequent frame as part of the potentially visible set of surfaces, the server may refrain from performing computations associated with the texel because the server may already store the influence of the shadow casters on the texel. Accordingly, in some specific implementations, the server may perform the computation (e.g., projecting the world-space position of the texel into the light-spaces for all shadow casters or light sources) only if the information is not already available (e.g., stored or recorded in the atlas G-buffer).

Particular aspects of the subject matter described in this disclosure may be implemented to realize one or more of the following potential advantages. In some implementations, the described techniques may enhance a rendering capability of a computer graphics device. For example, based on implementing an atlas-space shadow mask in object-space rendering, the device may reduce visual errors (e.g., visual artifacts) by determining shading information for potentially visible surfaces such that the shadow information for a number of surfaces invisible from a present view but potentially visible from nearby views may also be determined. In doing so, the device performing the atlas shading with the help of a shadow mask incorporates the correct shadow information even for currently invisible, but potentially visible, surfaces which may be disoccluded by the rendering device which uses the shading atlas to reconstruct the scene from a different viewpoint. Having the appropriate shadows incorporated in the newly-visible surfaces may improve realism and enhance spatial awareness. Implementing an atlas-space shadow mask in object-space rendering may be inefficient if implemented using previously available techniques, as compared to, for instance, the shadow mapping method in screen-space rendering. As such, a device employing the described techniques may enhance the experience of a user using split-rendering applications, while keeping the computational complexity bounded. Such applications may include cloud gaming, virtual reality, or augmented reality applications. Further, the described techniques for implementing a shadow map-based simplification in an object-space rendering pipeline may reduce the computational costs of current object-space shading pipelines.

Aspects of the disclosure are initially described in the context of multimedia systems. Aspects of the disclosure are then illustrated by and described with reference to a multi-view rendering system and a graphics pipeline that relate to an implementation of an atlas-space shadow mask. Aspects of the disclosure are further illustrated by and described with reference to apparatus diagrams, system diagrams, and flowcharts that relate to an implementation of an atlas-space shadow mask.

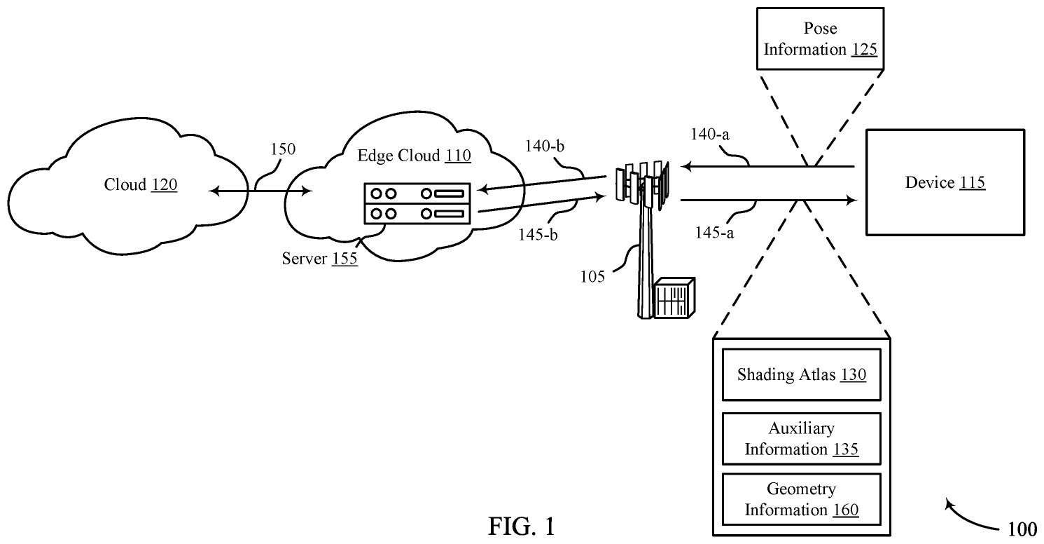

FIG. 1 illustrates a potential deployment of a split-rendering system 100 that supports an implementation of an atlas-space shadow mask in accordance with aspects of the present disclosure. The split-rendering system 100 may illustrate a distributed rendering pipeline between a server 155 and a device 115 (e.g., a personal device), which may be an example of a client device, such as a head mounted device (HMD), a handheld game client, or a headset (e.g., an XR headset). The server 155 may transmit one or more messages to the device 115, such as a shading atlas 130 and auxiliary information 135. Furthermore, the geometry (mesh) information 160 corresponding to potentially visible surfaces may also be transmitted to the client device as it becomes revealed. In some cases, the server 155 may transmit the messages via a relay node 105, which may act as a relay (e.g., a hop) between the server 155 and the device 115. As described herein, the server 155 may shade an atlas by implementing an atlas-space shadow mask to help with shading the atlas in object-space rendering and transmit the shading atlas 130 to the device 115. The device 115 may use the shading atlas 130, and the auxiliary information 135, to reconstruct the scene from a viewpoint of the device 115. The scene rendered by the device 115 may include accurate shadowing information for each a number of viewpoints of the device 115 based on the implementation of a shadow map-based simplification in object-space rendering.

The server 155 may transmit to the device 115 via a communication link 145, which may include a communication link 145-b from the server 155 to the relay node 105 and a communication link 145-a from the relay node 105 to the device 115. Additionally, the device 115 may transmit to the server 155 via a communication link 140. The communication link 140 may include a communication link 140-a from the device 115 to the relay node 105 and a communication link 140-b from the relay node 105 to the server 155. In some cases, the device 115 may provide pose information 125 to the server 155. The pose information 125 may include information relating to a position, an orientation, or a motion, or a combination thereof, of the viewpoints of the device 115, which are used by the server 155 to render a scene into the object-space primitives.

As described herein, the server 155 may offload some processing tasks to the device 115 to enhance the capabilities of the rendering pipeline. Such distributed processing may be supported by the low-latency, high capacity, and high quality of service associated with communication link 140 and communication link 145, which may be examples of communication links in a fifth generation (5G) new radio (NR) system. For example, split-rendering system 100 may operate within a 5G system and support high frequency communication, such as in the millimeter wave (mmW) frequency bands.

In some cases, the server 155 may perform processing of a visibility stage based on the pose information 125. For example, the server 155, upon receiving the pose information 125, may predict a set of future viewpoints that the device 115 may use to render a scene and may determine one or more potentially visible surfaces associated with the scene based on the prediction. For instance, the device 115 may employ a visual-inertial odometry or tracking system to measure the position and orientation of the viewpoints visited by the device 115 as the device 115 moves around in space and the server 155 may determine the one or more potentially visible surfaces based on the predicted pose, or a set of predicted poses, associated with the pose information 125 supplied by the device 115 (e.g., supplied at high rate by the device 115). In some cases, the server 155 may implement linear extrapolation or other techniques to determine the multitude of predicted poses used to identify potentially visible surfaces that the device 115 may display in a future frame. In some other cases, the server 155 may implement one of the alternative techniques for determining potentially visible surfaces, such as the occluder shrinking method based on the latest pose received from the device 115 (the client).

The server 155 may be associated with processing operations at an edge cloud 110 (e.g., server 155 may be an edge network device, such as an edge server). The edge cloud 110 may be associated with the edge of the network and may include computer programs that deliver low latency service to the device 115 or any other nearby device requesting service. For instance, the server 155 may be associated with edge computing and may be “on-premise” (e.g., within the venue of the device 115). As such, the edge cloud 110 may be associated with one or more processing tasks for applications in which real-time data processing is useful. As illustrated by FIG. 1, the edge cloud 110 may be one hop away from the device 115 (e.g., the client). This may enable the edge cloud 110 to achieve low latency response time constraints for real-time applications (e.g., cloud gaming applications). In some other cases, the edge cloud 110 may be two or more hops away from the device 115 but may still be able to meet the low latency time constraints of the device 115. Moreover, the split-rendering architecture based on object-space rendering, which relies on potential visibility, may be particularly well-suited for low-latency rendering applications because it allows the device 115 (the client) to compensate (and, in some instances, to flawlessly compensate) for a good portion of the incurred round-trip latency by rendering content according to the latest on-device pose.

Edge computing at the edge cloud 110 may achieve faster response times and transfer rates relative to the cloud 120 (e.g., the deeper network). The edge cloud 110 may communicate with the cloud 120 via a communication link 150. The cloud 120 may perform one or more processing tasks for the edge cloud 110 or the device 115. In some cases, the cloud 120 may process less latency-sensitive content, such as streaming recorded video. Also, edge servers may receive an update of the multimedia content assets (e.g., the assets in a game), which may usually be stored in a deep network or cloud, such as cloud 120.

In some implementations of the present disclosure, the server 155 may identify potentially visible surfaces for shading and represent the potentially visible surfaces in a shading atlas 130, determine a shadow factor associated with each texel of a number of texels corresponding to the one or more potentially visible surfaces based at least in part on an influence of a shadow caster or a group of shadow casters, and may store the shadow factor for each texel in an atlas shadow mask. In some examples, to determine the shadow factor for each texel, the server 155 may transform a set of world-space coordinates associated with the number of texels into a light-space of the shadow caster to generate a set of depth values. The server 155 may compare the generated set of depth values with a set of depth values associated with the shadow caster (e.g., depth values of the depth map of the shadow caster). Such depth maps or shadow maps may be generated once for all shadow casters (light sources) that are temporally static in space, and can then be re-used for the duration of the experience to determine the influence of this shadow caster on a number of surfaces determined dynamically.

In some aspects, the server 155 may transform the world-space coordinates of the texels corresponding to the potentially visible surfaces that are stored in the shading atlas 130 and, in some examples, the server 155 may determine which space of the shading atlas 130 is non-empty (e.g., includes information relating to a potentially visible surfaces) prior to transforming the world-space coordinates into the light-space of the shadow caster. As such, the server 155 may refrain from performing unnecessary processing computations associated with attempting to transform the world-space coordinates of empty space in the shading atlas 130. In some implementations, the server 155 may employ a stencil mask of zeros and ones to determine the non-empty space in the shading atlas 130 and may transform the world-space coordinates associated with the texels corresponding to the non-empty space in the shading atlas 130.

The server 155 may additionally determine the influence of a number of other shadow factors that at least partially influence a potentially visible surface stored in the shading atlas 130. For example, for each additional shadow caster, the server 155 may transform the world-space coordinates of the texels corresponding to the potentially visible surfaces into a light-space of the shadow caster to generate a set of depth values and may compare the generated set of depth values with the set of depth values associated with the shadow caster. Accordingly, the server 155 may determine a set of shadow factors for each additional shadow caster and may update the atlas shadow mask based on the sets of shadow factors. In some aspects, the server 155 may reuse the world-space coordinates generated when determining the influence of an initial shadow caster by storing the world-space coordinates in an atlas G-buffer from which the server 155 may retrieve the world-space coordinates when calculating the updates to the shadow factors (e.g., in between the light-space transform calculations).

The server 155 may update the atlas shadow mask such that the atlas shadow mask may include an accumulation of the influence of each shadow caster that at least partially influences the potentially visible surfaces. The server 155 may shade the shading atlas 130, in part, by applying the shadow information (e.g., the shadow factors) stored in the atlas shadow mask to the starting shading atlas 130 obtained with nominal lighting. The atlas shadow mask may be a convenient way to compute the influence of direct lighting and its blockage, and the server 155 may duly account for other sources of light and other factors that affect the shading of a texel (e.g., the frequency/color of light emitted by the light sources, etc.). The server 155 may transmit the shading atlas 130 (e.g., including the shadowing information from the atlas shadow mask) to the device 115 via communication link 145. The server 155 may additionally transmit one or more additional messages, including auxiliary information 135 and geometry information 160, to the device 115 that the device 115 may use to reconstruct the scene and output a display for a user.

For instance, the device 115 may rasterize the potentially visible geometry 160 onto the final display (single-view or multi-view, as in stereo view for HIVID devices, for example) using the most recent pose information, which is measured on the device 115 (the client) a number of milliseconds (e.g., a dozen milliseconds or approximately a dozen milliseconds) before the content is presented to the display and is fresher (e.g., 50 to 100 milliseconds, or more, fresher) than the pose information 125 transported by the device 115 that is used by the server 155 to shade the corresponding content. The auxiliary information 135 is used by the device 115 to describe where in the most recent shading atlas 130 to look for shades for different triangles rasterized on the display. These shades are then texture-mapped from atlas-space onto the screen, which concludes the reconstruction of the most recent view by the device 115.

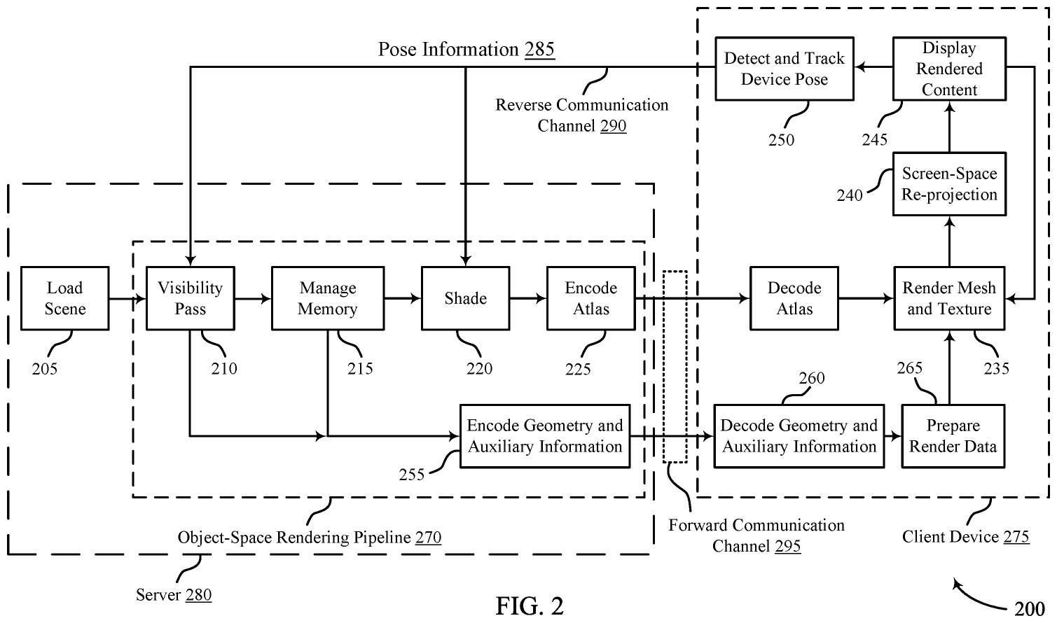

FIG. 2 illustrates an example of a graphics pipeline 200 that supports an implementation of an atlas-space shadow mask in accordance with aspects of the present disclosure. In some examples, the graphics pipeline 200 may implement aspects of the split-rendering system 100. For example, the graphics pipeline 200 may be distributed (e.g., a split-rendering system) where its parts may be implemented on a server 280 and other parts may be implemented on a client device 275, which may be examples of the server 155 and the device 115, respectively. In some cases, the components and functions of server 280 as shown in FIG. 2 may be referred to as a game engine that may be compatible with object-space rending pipeline 270 (e.g., vector streaming). In some examples, the graphics pipeline 200 may be used to render scenes with shadows formed by occluding sources of direct lighting in a scene by static objects. In some examples, the graphics pipeline 200 may be used to implement the use of atlas-space shadow masks in object-space rendering.

In some examples, the operations illustrated in graphics pipeline 200 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added. For example, the server 280 and the client device 275 may perform additional features, perform the described features in a different order, or refrain from performing some features without exceeding the scope of the present disclosure.

At 205, a pre-processing unit may load a scene (i.e., the scene assets, which may include asset meshes, textures/skins, material properties, etc.). The pre-processing unit may also be responsible for preparing the scene geometry and grouping geometric primitives into inseparable quants of information which may be delivered to the client device 275 as they become visible. For example, the pre-processor may load a virtual scene, such as an at least partially animated scene. The animated scene may include a number of assets, as in the animated objects. As the geometry information for each of the meshes is loaded, the pre-processing unit may decide to group pairs of neighboring triangles together in inseparable groups. These groups may be chosen such that their layout in a shading atlas is well represented using a rectangular shape. pre-processing unit may provide the loaded scene and pre-processed geometry to the server 280.

At 210, the server 280 may perform a visibility pass based on the loaded scene, the most recent pose information 285 (e.g., the most recent camera view), and an algorithm for determining potential visibility. In some examples, the server 280 may perform the visibility pass based on one or more camera views or a description of a viewcell surrounding one of the recent camera views in 6-dimensional space. The server 280 may determine which geometry and corresponding surfaces are potentially visible to one or more camera views and, therefore, should be shaded. The potential visibility is determined based on the granularity of triangle groups, also known as patches. In some examples, the visibility pass 210 may determine the potentially visible surfaces (patches) based on predicting a variety of future viewpoints that the client device 275 may occupy in a near future. Other algorithms for determining potential visibility are also possible. Accordingly, the server 280 may determine which surfaces, and which patches (e.g., which texels), are at least partially visible to a camera located in at least one of a number of camera views describing a viewcell, where the viewcell may be defined as a variety of discrete, predicted viewpoints that the client device 275 may occupy in a near future, by the time it is getting ready to render the primitives shaded in this instance on the server. The viewcell may also be defined as a totality of camera positions and orientations within a threshold distance from the current camera view (e.g., the position of the client device 275) or from the best known unique prediction of the camera view (the position of the client device 275 at the time of content rendering).

In some cases, the viewcell of the server 280 may be based, in part, on a prediction of what view the client device 275 may use to display the scene. For example, the server 280 may be aware (e.g., based on an input, such as an input from a pose detection stage at 145) of the pose and/or the motion of the pose used by the client device 275 and may determine the potentially visible surfaces based on predicting the viewpoint of the client device 275 at a time of final rendering of a subsequent display or on a variety of nearby viewpoints, within a threshold distance from the predicted view at the time of displaying the present scene renditions. Further, in addition to predicting the viewpoint of the client device 275, the server 280 may predict the motion of one or more objects (e.g., animated objects) at the predicted time of final rendering by the client device 275, which may further influence the set of potentially visible geometric primitives.

At 215, the server 280 may manage the memory associated with the atlas. For example, the server 280 may allocate, and de-allocate, space for patches stored in the atlas (e.g., a shading atlas, such as the shading atlas 130 as described with reference to FIG. 1) based on the potential visibility of the stored patches. For instance, patches that have become potentially visible (e.g., as determined at 210), may be allocated memory space in the atlas while patches that have become invisible (i.e., not visible from any camera view associated with the viewcell considered at 210) may be removed from the atlas. The server 280 may allocate space for a patch based on the projected area of the patch on the screen, which is determined using a unique position and orientation (e.g., based on a current estimate) of the client device 275 . This space is allocated once the patch initially becomes potentially visible, may remain the same as long as the motion of the client device 275 does not result in the re-evaluation of such space assignment, and may be assigned a different space (e.g., area in memory corresponding to a rectangle of different area and/or aspect ratio) as the camera viewpoint changes from the original viewpoint when the patch was first added to the atlas. In some examples, the server 280 may store world-space coordinates of the texels corresponding to the potentially visible surfaces that are stored in the atlas in an atlas G-buffer. In some implementations, the atlas G-buffer may be reusable such that the server 280 may retrieve the world-space coordinates stored in the atlas G-buffer throughout a shading operation, such as at 220.

At 220, the server 280 may shade the atlas (e.g., the shading atlas). In some cases, the operations performed at 220 may be performed by an atlas shading component, such as an atlas shading manager. The final shading applied to each of the triangles included in the shading atlas may be determined by a number of different factors, where one of those factors may be the amount and direction of lighting that the triangle receives. In some examples, the server 280 may accumulate the influence of (e.g., the amount of light received from) a number of shadow casters (e.g., light sources) that influence the potentially visible surfaces to determine of the values of shadow factors associated with the potentially visible surfaces (e.g., associated with texels corresponding to the potentially visible surfaces). For example, the server 280 may, for each shadow caster, transform the world-space coordinates of the potentially visible texels into the light-space of the shadow caster to determine a set of depth values which each of these texels would register at the appropriate quad location if observed from the perspective of the corresponding light source. Because these depth values may also be organized into an “image” (e.g., by the horizontal and vertical angle of the corresponding texel as compared to the equivalent camera axis of the light source), the resulting quad may be referred to or thought of as a depth map. The server 280 may compare the depth values associated with such a depth map to a set of depth values pre-stored in the shadow map—a depth map measured from the exact viewpoint of the corresponding shadow caster, which may remain static in its position and orientation.

The server 280, based on the depth map comparison performed with respect to a number of shadow casters, may determine a number of shadow factors associated with the texels corresponding to the potentially visible surfaces and may store the shadow factors in an atlas shadow mask—a temporary structure which by shape may resemble the corresponding areas in a shading atlas. As such, the server 280 may accumulate the influence of each shadow caster on the potentially visible surfaces by updating the shadow factors stored within the atlas shadow mask. The server 280 may apply the atlas shadow mask when determining the final shade of each texel constituting the potentially visible surfaces stored in the atlas.

In some implementations, the server 280 may retrieve the world-space coordinates stored in the atlas G-buffer before calculating the influence of each shadow caster. For example, the server 280 may generate the set of world-space coordinates and store the world-space coordinates in the atlas G-buffer prior to determining the influence of a first shadow caster (e.g., prior to transforming the world-space coordinates into the light-space of the first shadow caster). While determining the influence of a second shadow caster, the server 280 may retrieve the world-space coordinates from the atlas G-buffer and transform the world-space coordinates into the light-space of the second shadow caster. In some cases, the server 280 may retrieve the world-space coordinates from the atlas G-buffer based on a feedback operation (e.g., a transform feedback operation). As such, the server 280 may retrieve the world-space coordinates when determining the influence of each shadow caster and, therefore, avoid generating the world-space coordinates for each shadow caster, which may be associated with high computational costs.

At 225, the server 280 may encode the shading atlas before passing the shading atlas to the client device 275. For example, the server 280 may prepare the shading atlas for transmission to the client device 275 via a forward communication channel 295. The server 280 may transmit the shading atlas to the client device 275 via a wired or a wireless connection, for example, such as forward communication channel(s) 295 may refer to a wired connection or a wireless communication channel (e.g., a same link). In some examples, the server 280 may transmit the shading atlas to the client device 275 over a wireless communication link, via the forward communication channel 295, in a 5G NR system, such as a communication link 145 as described with reference to FIG. 1. In some cases, the shading atlas may be encoded as a moving picture experts group (MPEG) stream. In some other cases, the server 280 may use an H.264 video coding standard to encode the shading atlas.

At 255, the server 280 may additionally encode the geometry and the auxiliary information associated with the scene and pass the encoded geometry and auxiliary information to the client device 275 via the forward communication channel 295. For example, the server 280 may encode the vertices, triangles, and texels (e.g., texture coordinates for each of the potentially visible patches in the shading atlas) as meta-information that the server 280 may also send to the client device 275 in separate messages with separate methods of encoding and error concealment. In some cases, the vertices and triangles are transmitted to the client device 275 once (e.g., when they first become visible) and patch information are transmitted periodically (e.g., whenever patches are re-located in the atlas). In some cases when the server 270 transmits the geometry and the auxiliary information to the client device 275 over the forward communication channel 295, the server 270 may use a proprietary protocol (e.g., TCP proprietary) to increase the likelihood of safe receipt of information despite interference and fading associated with the wireless transportation over the forward communication channel 295.

At 230, the client device 275 may receive the encoded atlas and may decode the atlas. Additionally, at 260, the client device 275 may decode the geometry of the scene. In some cases, the client device 275 may also decode the messages received from the server 280 upon the arrival of the messages (e.g., immediately upon arrival) and update the internal structures of the client device 275 based on the messages. In some cases, the client device 275 may employ MPEG decoding to decode the atlas on a dedicated hardware unit and may decode the meta-information on the CPU and/or the GPU of the client device 275. The client device 275 may receive information from the server 280 over the network over two separate connections (e.g., at 230 and at 260), and the client device 275 may accordingly perform one or more operations to ensure that the streams are synchronized after information is fully received and decoded.

At 265, the client device 275 may prepare rendering pipelines associated with rendering and displaying the received scene information. In some cases, preparing the render pipelines and identifying the data to be processed may include handling the messages received from the server 280 (e.g., handling the auxiliary information).

At 235, the client device 275 may render meshes and textures associated with the scene. In some examples, the client device 275 may render the meshes based on the received geometry as well as the geometry already stored in the internal memory. The client device 275 may render the textures based on the freshly received shading atlas and the auxiliary information received from the server 280.

At 240, the client device 275 may perform certain screen-space manipulations in preparation of the rendered content for the display in viewer mechanical systems. Examples of such screen-space manipulations include chromatic aberration correction and lens distortion correction, which may both be standardly applied prior to display in HMDs, or in some instances asynchronous time warping in order to further correct for the small time-delay between the rendering operation at 235 and the corresponding display operation at 245.

At 245, the client device 275 may perform a final processing stage for the current frame and display the rendered content. The content display stage may be timed by a separate synchronization signal, which may sometimes be referred to as V-sync, that may ensure (or increase the likelihood of) accurate and uniform intra-frame spacing.

At 250, the client device 275 may perform an initial processing stage for a subsequent frame rendering cycle and may detect and track the pose of the client device 275. In some cases, the client device 275 may estimate the position and orientation of the client device 275 at high frequency. For instance, the client device 275 may estimate position and orientation at a frequency up to or more than 50 times the frequency of display refresh signals. The client device 275 may prepare pose information 285 based on the pose detection and tracking and may prepare the pose information 285 for transmission in pose packets. These pose packets are sent to the server 280 in a reverse communication channel 290 and the pose information 285 may be used by the server 280 directly or indirectly in a next frame rendering cycle. In some implementations, the client device 275 may also perform pose prediction and transmit predicted pose information 285. In some other implementations, the server 280 may receive the pose information 285 and may implement a pose prediction algorithm based on the raw poses and the corresponding timestamps received from the client device 275.

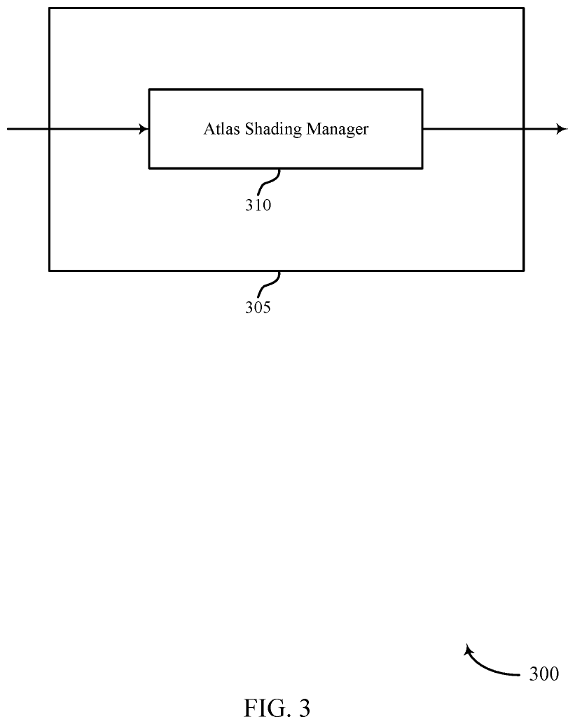

FIG. 3 shows a block diagram 300 of a device 305 that supports implementation of an atlas-space shadow mask in accordance with aspects of the present disclosure. In some cases, the device 305 may be an example of aspects of a GPU or other hardware of a server, such as the server 155 or the server 165 as described with reference to FIGS. 1 and 2, respectively. The device 305 may include an atlas shading manager 310. The device 305 may also include a processor. Each of these components may be in communication with one another (e.g., via one or more buses).

The atlas shading manager 310 may receive an output of the memory management stage (e.g., a list of potentially visible patches together with the location and dimensions that the shaded patches may occupy in the atlas), single pose information (e.g., one prediction of the position and orientation a client device may occupy close to the time of a client display), and other assets associated with the scene (e.g., light sources, their properties, information about animated objects: the meshes, textures, other properties, etc.).

The atlas shading manager 310 may determine the nominal shading of all potentially visible patches based on the scene objects and properties, as well as the pose used for shading. The atlas shading manager 310 may subsequently determine a shadow factor associated with each texel of a number of potentially visible texels based on the first influence of the first shadow caster, and store the shadow factor for each texel of the number of texels in an atlas shadow mask. The atlas shading manager 310 may be an example of aspects of the atlas shading manager 650 described herein.

Additionally or alternatively, the atlas shading manager 310 may determine the nominal shading of all potentially visible patches based on the scene objects and properties, as well as the pose used for shading. The atlas shading manager 310 may also determine a set of world-space coordinates for a number of potentially visible texels corresponding to the one or more potentially visible patches (e.g., surfaces) and store the set of world-space coordinates in an atlas G-buffer and determine a first influence of a first shadow caster on the one or more potentially visible patches based on the set of world-space coordinates and a first set of depth values associated with the first shadow caster. The atlas shading manager 310 may subsequently determine a shadow factor associated with each texel of the number of potentially visible texels based on the first influence of the first shadow caster and store the shadow factor for each texel of the number of potentially visible texels in an atlas shadow mask. The atlas shading manager 310 may be an example of aspects of the atlas shading manager 650 described herein.

The atlas shading manager 310, or its sub-components, may be implemented in hardware, code (e.g., software or firmware) executed by a processor, or any combination thereof. If implemented in code executed by a processor, the functions of the atlas shading manager 310, or its sub-components may be executed by a general-purpose processor, a GPU, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The atlas shading manager 310, or its sub-components, may be physically located at various positions, including being distributed such that portions of functions are implemented at different physical locations by one or more physical components. In some examples, the atlas shading manager 310, or its sub-components, may be a separate and distinct component in accordance with various aspects of the present disclosure. In some examples, the atlas shading manager 310, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The atlas shading manager 310 may output information from the atlas shading manager 310 to an encoder. In some examples, the atlas shading manager 310 may transmit the shading atlas to an encoder that may later be sent to a client device for use in rendering a display of a scene with shading, as described in more detail with reference to FIGS. 1 and 2.

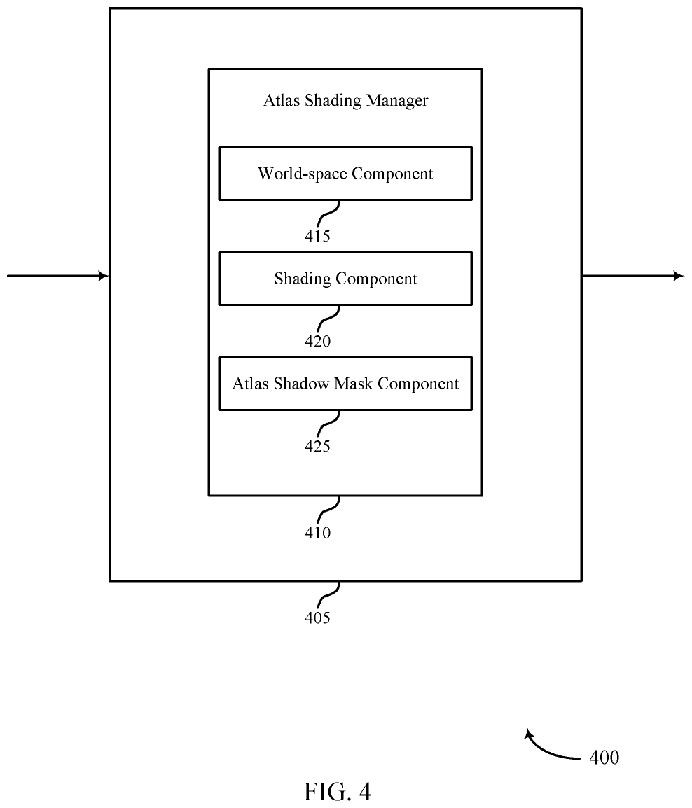

FIG. 4 shows a block diagram 400 of a device 405 that supports implementation of an atlas-space shadow mask and use it for producing the final texel shading in a computationally efficient manner in accordance with aspects of the present disclosure. The device 405 may be an example of aspects of a device 305, such as a server or a GPU of a server. The device 405 may include an atlas shading manager 410. The device 405 may also include a processor. Each of these components may be in communication with one another (e.g., via one or more buses).

The atlas shading manger 410 may receive an output of the memory management stage (e.g., a list of potentially visible patches together with the location and dimensions that the shaded patches may occupy in the atlas), single pose information (e.g., one prediction of the position and orientation a client device may occupy close to the time of a client display), and other assets associated with the scene (e.g., light sources, their properties, information about animated objects: the meshes, textures, other properties, etc.).

The atlas shading manager 410 may be an example of aspects of the atlas shading manager 310 as described herein. The atlas shading manager 410 may include, a world-space component 415, a shading component 420, and an atlas shadow mask component 425. The atlas shading manager 410 may be an example of aspects of the atlas shading manager 650 described herein.

The world-space component 415 may determine a set of world-space coordinates for a number of texels corresponding to the one or more potentially visible surfaces and store the set of world-space coordinates in an atlas G-buffer. The shading component 420 may determine a first influence of a first shadow caster on the one or more potentially visible surfaces based on the set of world-space coordinates and a first set of depth values associated with the first shadow caster and determine a shadow factor associated with each texel of the number of texels based on the first influence of the first shadow caster. The atlas shadow mask component 425 may store the shadow factor for each texel of the number of texels in an atlas shadow mask. The shading component 420 may perform a shading for the one or more potentially visible surfaces in the atlas based on the atlas shadow mask. In some examples, the shading component 420 may perform the shading for the one or more potentially visible surfaces in the atlas once the atlas shadow mask accumulates the influence for the shadow casters that influence the one or more potentially visible surfaces.

The atlas shading manager 410 may output information from the atlas shading manager 410 to an encoder. In some examples, the atlas shading manger 410 may transmit the shading atlas to an encoder that may later be sent to a client device for use in rendering a display of a scene with shading, as described in more detail with reference to FIGS. 1 and 2.

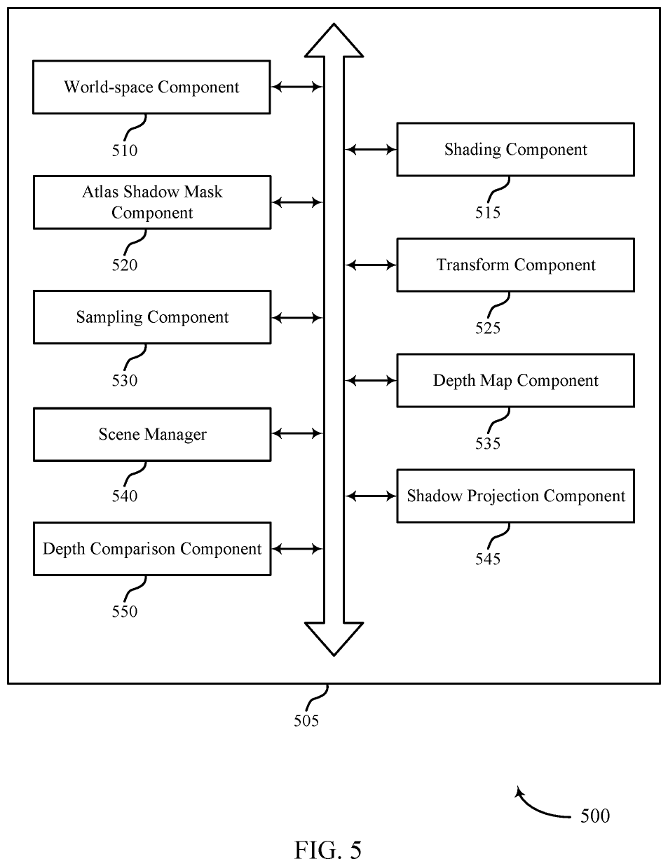

FIG. 5 shows a block diagram 500 of an atlas shading manager 505 that supports implementation of an atlas-space shadow mask in accordance with aspects of the present disclosure. The atlas shading manager 505 may be an example of aspects of an atlas shading manager 310, an atlas shading manager 410, or an atlas shading manager 650 described herein. The atlas shading manager 505 may include a world-space component 510, a shading component 515, an atlas shadow mask component 520, a transform component 525, a sampling component 530, a depth map component 535, a scene manager 540, a shadow projection component 545, and a depth comparison component 550. Each of these modules may communicate, directly or indirectly, with one another (e.g., via one or more buses).

The world-space component 510 may determine a set of world-space coordinates for a number of texels corresponding to the one or more potentially visible surfaces and storing the set of world-space coordinates in an atlas G-buffer. In some examples, the world-space component 510 may determine the set of world-space coordinates for the number of texels corresponding to the one or more potentially visible surfaces based at least in part on retrieving the set of world-space coordinates from the atlas G-buffer, wherein the atlas G-buffer is a reusable atlas G-buffer. In some examples, the world-space component 510 may generate the set of world-space coordinates corresponding to the one or more potentially visible surfaces based on determining a world-space coordinate associated with each texel of the number of texels corresponding to the one or more potentially visible surfaces. In some examples, the world-space component 510 may determine a first world-space coordinate for a first texel of the number of texels and determine the first influence of the first shadow caster on the first texel and store the first influence of the first shadow caster on the first texel together with the first world-space coordinate for the first texel in the atlas G-buffer.

The shading component 515 may determine a first influence of a first shadow caster on the one or more potentially visible surfaces based on the set of world-space coordinates and a first set of depth values associated with the first shadow caster. In some examples, the shading component 515 may determine a shadow factor associated with each texel of the number of texels based on the first influence of the first shadow caster. In some examples, the shading component 515 may compare the second set of depth values to the first set of depth values. In some examples, the shading component 515 may determine a second influence of a second shadow caster on the one or more potentially visible surfaces based on the set of world-space coordinates and a third set of depth values associated with the second shadow caster. In some examples, the shading component 515 may update the shadow factor associated with each texel of the number of texels based on the second influence of the second shadow caster. In some examples, the shading component 515 may determine that the first shadow caster or the second shadow caster, or both, influences the texel.

The shading component 515 may perform a shading for the one or more potentially visible surfaces in the atlas based on the atlas shadow mask. In some examples, the shading component 515 may perform a shading for the texel based on a corresponding shadow factor in the atlas shadow mask. In some cases, the one or more potentially visible surfaces are represented in an atlas for consumption on a client device. The atlas shadow mask component 520 may store the shadow factor for each texel of the number of texels in an atlas shadow mask. In some examples, the atlas shadow mask component 520 may store an updated shadow factor for each texel of the number of texels in the atlas shadow mask. For example, the atlas shadow mask component 520 may accumulate the influence of each of a number of shadow casters that influence the potentially visible surfaces.

The transform component 525 may generate a second set of depth values corresponding to the set of world-space coordinates transformed to a first light-space associated with the first shadow caster based at least in part on projecting the world-space coordinates into the first light-space. In some examples, the transform component 525 may generate a fourth set of depth values corresponding to the set of world-space coordinates transformed to a second light-space associated with the second shadow caster. In some examples, the transform component 525 may transform the set of world-space coordinates into the light-space for each shadow caster of the number of shadow casters that influence the potentially visible surfaces. In some examples, the transform component 525 may determine whether the atlas G-buffer comprises the first influence of the first shadow caster for at least a subset of the set of world-space coordinates stored in the atlas G-buffer and may transform the set of world-space coordinates that are absent of the first influence of the first shadow caster in the atlas G-buffer. In some examples, the transform component 525 may perform similar functions to the shadow projection component 545.

The sampling component 530 may sample the second set of depth values and the first set of depth values and perform the comparison of the second set of depth values to the first set of depth values. The depth map component 535 may store and/or generate a depth map (e.g., a shadow depth map) associated with each shadow caster of a number of shadow casters that may influence the potentially visible surfaces. In some cases, the first set of depth values are stored in a first depth map associated with the first shadow caster. In some cases, the third set of depth values are stored in a second depth map associated with the second shadow caster. The scene manager 540 may receive the scene assets associated with a scene to be displayed. In some cases, a scene associated with the shading operation corresponds to a virtual scene. In some cases, a scene associated with the shading operation corresponds to an at least partially animated scene. In some cases, the at least partially animated scene is used in at least one of a cloud gaming application, a virtual reality application, or an augmented reality application.

The shadow projection component 545 may project the world-space coordinates into the second light-space based at least in part on a position, an orientation, a field of view, a horizontal and vertical sampling resolution, or a combinations thereof, of the second shadow caster, wherein projecting the world-space coordinates into the second light-space generates the fourth set of depth values. In some examples, the shadow projection component 545 may project the world-space coordinates into a two dimensional (2D) object that is compatible with a depth map (i.e., also a 2D object) associated with a shadow caster (e.g., a light source). The depth comparison component 550 may compare texels in the second set of depth values to texels at corresponding locations in the first set of depth values based on the sampling. In some examples, the depth comparison component 550 may compare the fourth set of depth values to the third set of depth values.

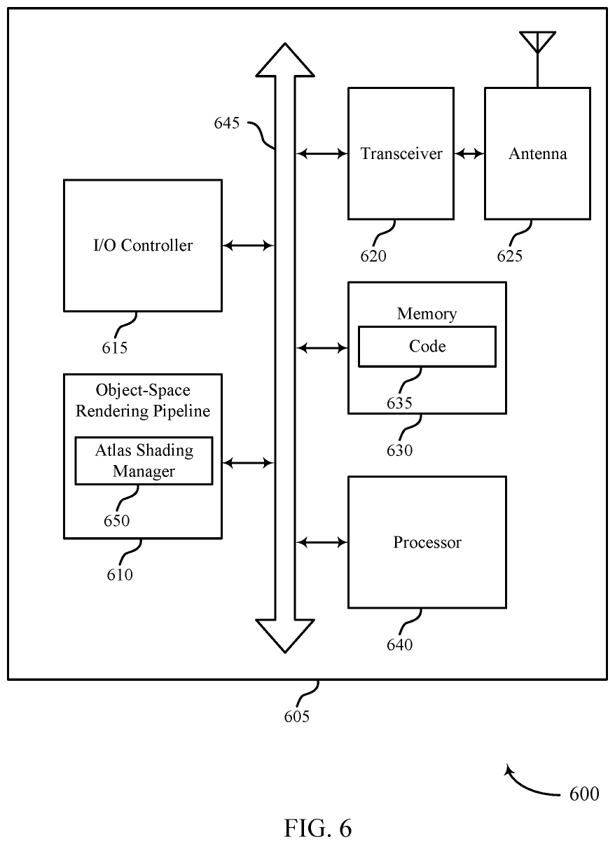

FIG. 6 shows a diagram of a system 600 including a device 605 that supports implementation of an atlas-space shadow mask in accordance with aspects of the present disclosure. The device 605 may be an example of or include the components of device 305, device 405, or a device as described herein. The device 605 may include components for bi-directional voice and data communications including components for transmitting and receiving communications, including an object-space rendering pipeline 610, an I/O controller 615, a transceiver 620, an antenna 625, memory 630, a processor 640, and an atlas shading manager 650. These components may be in electronic communication via one or more buses (e.g., bus 645).

The object-space rendering pipeline 610 may implement one or more of the techniques described herein. In some examples, the object-space rendering pipeline 610 may be an example of the object-space rendering pipeline 270, as described with reference to FIG. 2. In some examples, the object-space rendering pipeline 610 may include the atlas shading manager 650. For instance, the atlas shading manager 650 may perform one or more operations performed within the object-space rendering pipeline 610, such as those performed at 220 by an atlas shading component, as described with reference to FIG. 2.

The atlas shading manager 650 may identify one or more surfaces for a shading operation in an object-space shading pipeline that are to be represented in an atlas, determine a shadow factor associated with each texel of the number of texels based on the first influence of the first shadow caster, and store the shadow factor for each texel of the number of texels in an atlas shadow mask. As detailed herein, the atlas shading manager 650 and/or one or more components of the atlas shading manager 650 may perform and/or be a means for performing, either alone or in combination with other elements, one or more operations for supporting an implementation of an atlas-space shadow mask.

Additionally or alternatively, the atlas shading manager 650 may identify one or more surfaces for a shading operation in an object-space shading pipeline that are to be represented in an atlas, determine a set of world-space coordinates for a number of texels corresponding to the one or more surfaces and storing the set of world-space coordinates in an atlas G-buffer, determine a first influence of a first shadow caster on the one or more surfaces based on the set of world-space coordinates and a first set of depth values associated with the first shadow caster, determine a shadow factor associated with each texel of the number of texels based on the first influence of the first shadow caster, and store the shadow factor for each texel of the number of texels in an atlas shadow mask. As detailed herein, the atlas shading manager 650 and/or one or more components of the atlas shading manager 650 may perform and/or be a means for performing, either alone or in combination with other elements, one or more operations for supporting an implementation of an atlas-space shadow mask.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The transceiver 620 may communicate bi-directionally, via one or more antennas, wired, or wireless links as described herein. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas. In some cases, the device 605 may include a single antenna 625. However, in some cases, the device 605 may have more than one antenna 625, which may be capable of concurrently transmitting or receiving multiple wireless transmissions.

The memory 630 may include random-access memory (RAM) and read-only memory (ROM). The memory 630 may store computer-readable, computer-executable code 635 including instructions that, when executed, cause the processor to perform various functions described herein. In some cases, the memory 630 may contain, among other things, a basic I/O system (BIOS) which may control basic hardware or software operation such as the interaction with peripheral components or devices.

The code 635 may include instructions to implement aspects of the present disclosure, including instructions to support multimedia. The code 635 may be stored in a non-transitory computer-readable medium such as system memory or other type of memory. In some cases, the code 635 may not be directly executable by the processor 640 but may cause a computer (e.g., when compiled and executed) to perform functions described herein.

The processor 640 may include an intelligent hardware device, (e.g., a general-purpose processor, a GPU, a DSP, a central processing unit (CPU), a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting implementation of an atlas-space shadow mask).

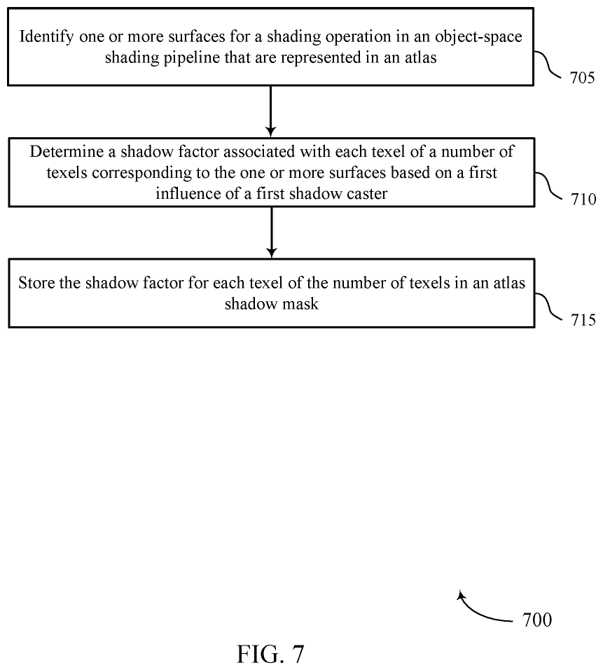

FIG. 7 shows a flowchart illustrating a method 700 that supports implementation of an atlas-space shadow mask in accordance with aspects of the present disclosure. The operations of method 700 may be implemented by a device or its components as described herein. For example, the operations of method 700 may be performed by an atlas shading manager as described with reference to FIGS. 3 through 6. In some examples, a device, such as a server, may execute a set of instructions to control the functional elements of the device to perform the functions described herein. Moreover, the functions described herein may be implemented by an atlas shading component or an atlas shading manager, such as the atlas shading component described at 220 with reference to FIG. 2. Additionally or alternatively, a device may perform aspects of the functions described herein using special-purpose hardware.

At 705, the device may identify one or more surfaces for a shading operation in an object-space shading pipeline that are represented in an atlas. The operations of 705 may be performed according to the methods described herein. In some examples, aspects of the operations of 705 may be performed by an atlas shading component as described at 220 with reference to FIG. 2 or by an atlas shading manager as described with reference to FIGS. 3 through 6.

At 710, the device may determine a shadow factor associated with each texel of a number of texels corresponding to the one or more surfaces based on a first influence of a first shadow caster. The operations of 710 may be performed according to the methods described herein. In some examples, aspects of the operations of 710 may be performed by a shading component as described with reference to FIGS. 3 through 6.

At 715, the device may store the shadow factor for each texel of the number of texels in an atlas shadow mask. The operations of 715 may be performed according to the methods described herein. In some examples, aspects of the operations of 715 may be performed by an atlas shadow mask component as described with reference to FIGS. 3 through 6.

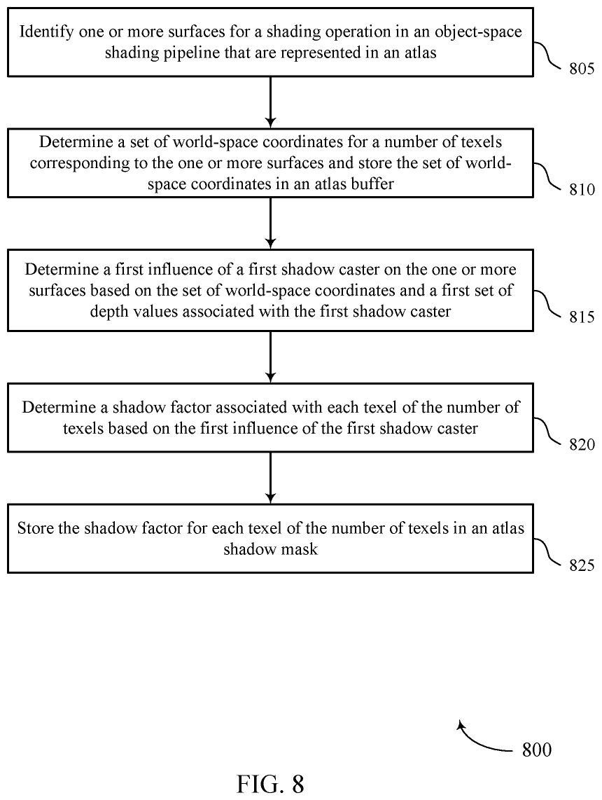

FIG. 8 shows a flowchart illustrating a method 800 that supports implementation of an atlas-space shadow mask in accordance with aspects of the present disclosure. The operations of method 800 may be implemented by a device or its components as described herein. For example, the operations of method 800 may be performed by an atlas shading manager as described with reference to FIGS. 3 through 6. In some examples, a device, such as a server, may execute a set of instructions to control the functional elements of the device to perform the functions described herein. Moreover, the functions described herein may be implemented by an atlas shading component or an atlas shading manager, such as the atlas shading component described at 220 with reference to FIG. 2. Additionally or alternatively, a device may perform aspects of the functions described herein using special-purpose hardware.

At 805, the device may identify one or more surfaces for a shading operation in an object-space shading pipeline that are represented in an atlas. The operations of 805 may be performed according to the methods described herein. In some examples, aspects of the operations of 805 may be performed by an atlas shading component as described at 220 with reference to FIG. 2 or by an atlas shading manager as described with reference to FIGS. 3 through 6.

At 810, the device may determine a set of world-space coordinates for a number of texels corresponding to the one or more surfaces and store the set of world-space coordinates in an atlas G-buffer. The operations of 810 may be performed according to the methods described herein. In some examples, aspects of the operations of 810 may be performed by a world-space component as described with reference to FIGS. 3 through 6.

At 815, the device may determine a first influence of a first shadow caster on the one or more surfaces based on the set of world-space coordinates and a first set of depth values associated with the first shadow caster. In other words, the device may determine a first number of shadow factors associated with a first number of texels of the one or more surfaces based in part on the set of world-space coordinates of the first number of texels and on the viewpoint (e.g., position and orientation) of the first shadow caster. The operations of 815 may be performed according to the methods described herein. In some examples, aspects of the operations of 815 may be performed by a shading component as described with reference to FIGS. 3 through 6.

At 820, the device may determine a shadow factor associated with each texel of the number of texels based on the first influence of the first shadow caster. The operations of 820 may be performed according to the methods described herein. In some examples, aspects of the operations of 820 may be performed by a shading component as described with reference to FIGS. 3 through 6.

At 825, the device may store the shadow factor for each texel of the number of texels in an atlas shadow mask. The operations of 825 may be performed according to the methods described herein. In some examples, aspects of the operations of 825 may be performed by an atlas shadow mask component as described with reference to FIGS. 3 through 6.

The methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for computer graphics at a device, comprising:
identifying one or more surfaces for a shading operation in an object-space shading pipeline that are represented in an atlas;
determining a set of world-space coordinates for a number of texels corresponding to the one or more surfaces and storing the set of world-space coordinates in an atlas geometry buffer (G-buffer);
determining a first influence of a first shadow caster on the one or more surfaces based at least in part on the set of world-space coordinates and a first set of depth values associated with the first shadow caster;
determining a shadow factor associated with each texel of the number of texels corresponding to the one or more surfaces based at least in part on the first influence of the first shadow caster; and
storing the shadow factor for each texel of the number of texels in an atlas shadow mask.

2. (canceled)

3. The method of claim 1, wherein determining the first influence of the first shadow caster on the one or more surfaces further comprises:
transforming the set of world-space coordinates into a first light-space associated with the first shadow caster to generate a second set of depth values; and
comparing the second set of depth values to the first set of depth values.

4. The method of claim 3, wherein transforming the set of world-space coordinates into the first light-space further comprises:
determining a non-empty space in the atlas based at least in part on constructing a stencil mask of a set of integers, wherein a first integer is associated with an empty space in the atlas and a second integer is associated with the non-empty space in the atlas; and
transforming the set of world-space coordinates associated with the non-empty space in the atlas.

5. The method of claim 3, wherein transforming the set of world-space coordinates into the first light-space further comprises:
determining whether the atlas G-buffer comprises the first influence of the first shadow caster for at least a subset of the set of world-space coordinates stored in the atlas G-buffer; and
transforming the set of world-space coordinates that are absent of the first influence of the first shadow caster in the atlas G-buffer.

6. The method of claim 1, further comprising:
determining a second influence of a second shadow caster on the one or more surfaces based at least in part on the set of world-space coordinates and a third set of depth values associated with the second shadow caster;
updating the shadow factor associated with each texel of the number of texels based at least in part on the second influence of the second shadow caster;
storing the updated shadow factor for each texel of the number of texels in the atlas shadow mask; and
performing a shading for the one or more surfaces in the atlas based at least in part on the atlas shadow mask.

7. The method of claim 6, wherein determining the second influence of the second shadow caster on the one or more surfaces further comprises:
generating a fourth set of depth values corresponding to the set of world-space coordinates transformed to a second light-space associated with the second shadow caster; and
comparing the fourth set of depth values to the third set of depth values.

8. The method of claim 7, wherein generating the fourth set of depth values corresponding to the set of world-space coordinates transformed to the second light-space associated with the second shadow caster further comprises:
determining the set of world-space coordinates for the number of texels corresponding to the one or more surfaces based at least in part on retrieving the set of world-space coordinates from the atlas G-buffer, wherein the atlas G-buffer is a reusable atlas G-buffer; and
projecting the set of world-space coordinates into the second light-space based at least in part on a position, an orientation, a field of view, a horizontal and vertical sampling resolution, or a combination thereof, of the second shadow caster, wherein projecting the set of world-space coordinates into the second light-space generates the fourth set of depth values.

9. The method of claim 6, wherein performing the shading for the one or more surfaces in the atlas further comprises:
identifying a texel of the number of texels corresponding to the one or more surfaces;
performing a shading for the texel based at least in part on a corresponding shadow factor stored in the atlas shadow mask.

10. The method of claim 1, wherein determining the set of world-space coordinates corresponding to the one or more surfaces is based at least in part on determining a world-space coordinate associated with each texel of the number of texels corresponding to the one or more surfaces.

11. The method of claim 1, further comprising:
determining a first world-space coordinate for a first texel of the number of texels and determining the first influence of the first shadow caster on the first texel; and
storing the first influence of the first shadow caster on the first texel together with the first world-space coordinate for the first texel in the atlas G-buffer.

12. The method of claim 1, wherein the one or more surfaces are represented in the atlas for consumption on a client device.

13. The method of claim 12, wherein the client device renders a subset of the one or more surfaces based at least in part on a current client position or orientation, or both.

14. The method of claim 1, wherein a scene associated with the shading operation corresponds to an at least partially animated scene.

15. The method of claim 14, wherein the at least partially animated scene is used in at least one of a cloud gaming application, a virtual reality application, or an augmented reality application.

16. An apparatus for computer graphics, comprising:
a processor,
memory coupled with the processor; and
instructions stored in the memory and executable by the processor to cause the apparatus to:
identify one or more surfaces for a shading operation in an object-space shading pipeline that are represented in an atlas;
determine a set of world-space coordinates for a number of texels corresponding to the one or more surfaces and storing the set of world-space coordinates in an atlas geometry buffer (G-buffer);
determine a first influence of a first shadow caster on the one or more surfaces based at least in part on the set of world-space coordinates and a first set of depth values associated with the first shadow caster;
determine a shadow factor associated with each texel of the number of texels corresponding to the one or more surfaces based at least in part on the first influence of the first shadow caster; and
store the shadow factor for each texel of the number of texels in an atlas shadow mask.

17. (canceled)

18. The apparatus of claim 16, wherein the instructions to determine the first influence of the first shadow caster on the one or more surfaces are further executable by the processor to cause the apparatus to:
generate a second set of depth values corresponding to the set of world-space coordinates transformed to a first light space associated with the first shadow caster; and
compare the second set of depth values to the first set of depth values.

19. The apparatus of claim 18, further comprising:
determine a second influence of a second shadow caster on the one or more surfaces based at least in part on the set of world-space coordinates and a third set of depth values associated with the second shadow caster;
update the shadow factor associated with each texel of the number of texels based at least in part on the second influence of the second shadow caster;
store the updated shadow factor for each texel of the number of texels in the atlas shadow mask; and
perform a shading for the one or more surfaces in the atlas based at least in part on the atlas shadow mask.

20. An apparatus for computer graphics, comprising:
means for identifying one or more surfaces for a shading operation in an object-space shading pipeline that are represented in an atlas;
means for determining a set of world-space coordinates for a number of texels corresponding to the one or more surfaces and storing the set of world-space coordinates in an atlas geometry buffer (G-buffer);
means for determining a first influence of a first shadow caster on the one or more surfaces based at least in part on the set of world-space coordinates and a first set of depth values associated with the first shadow caster;
means for determining a shadow factor associated with each texel of the number of texels based at least in part on the first influence of the first shadow caster; and
means for storing the shadow factor for each texel of the number of texels in an atlas shadow mask.
